(19) United States
(12) Patent Application Publication
(10) Pub. No.: US 2008/0134653 A1
(43) Pub. Date: Jun. 12, 2008

(54) Sealess filtration device

(76) Inventors: Neville Bugli, Novi, MI (US); Hovie Cassell, Birmingham, MI (US); Roger Khami, Troy, MI (US); Stephen Hamby, Livonia, MI (US); Ryan Grimes, Chongqing (CN)

Correspondence Address: FRASER CLEMENS MARTIN & MILLER LLC, 28366 KENSINGTON LANE, PERRYSBURG, OH, 43551, US

(21) Appl. No.: 11/635,334

(22) Filed: Dec. 7, 2006

(51) Int. Cl. B01D 46/00

(52) U.S. Cl. 55/502

(57) ABSTRACT

A filtration device is disclosed having a filter element and two housing shells, wherein one of the housing shells has a flange with a protuberance and the other housing shell has a flange with an indentation. The filter element has a flange peripheral portion compressed in the joint between the flanges.

### FIELD OF THE INVENTION

The invention relates to a filtration device and more particularly an engine filter assembly including a filter element and a filter housing having a first shell and a second shell, wherein the filter element cooperates with the first shell and the second shell to eliminate a requirement for a seal.

### BACKGROUND OF THE INVENTION

An internal combustion engine requires clean, filtered air to survive the durability demands of today's higher mileage requirements. A typical air filtration assembly is limited by current technology requiring a filter housing to be completely sealed to prevent unfiltered air from entering the engine through a leak path created by a joint between two filter housing shells. The filter housing shells require a specific, flanged-type seal around the perimeter of the filter element to seal the joint between the filter housing shells.

Further, the filter assembly often requires extra manufacturing processes to form the flange-type seal. The seal is typically produced from a variety of materials including thermoplastic resins, closed-cell foams, hot melts, polyurethane glues, silicone, and felts, which add cost. Typical manufacturing methods of the seal often limit assembly design to a rectangular or round shape. Shape has a dramatic influence on the filter assembly's fit to a motor vehicle.

U.S. Pat. No. 6,508,851 discloses a filter assembly consisting of a filter element with a non-woven material flange sealing the joint between the housing shells. The seal, made deformable by mounting forces, is pressed into at least one clamping groove by at least one clamping rib. The clamping groove is formed sufficiently deep that the seal made of fibrous non-woven material (e.g. a synthetic resin) does not contact the groove bottom. This filter assembly is said to seal tightly and prevent dirty, unfiltered air from leaking into the clean, filtered air. The required non-woven material, clamping grooves and ribs increase the complexity and cost of manufacture for the filter assembly.

It would be desirable to have a filtration device for an internal combustion engine which filters air in a leak path created by a joint between filter housing shells, while allowing irregular housing shapes and which is simple and inexpensive to manufacture.

### SUMMARY OF THE INVENTION

In concordance and agreement with the present invention, a filtration device which filters air in a leak path created by a joint between filter housing shells, while allowing irregular housing shapes and which is simple and inexpensive to manufacture, has surprisingly been discovered.

In one embodiment, the filtration assembly comprises a first housing shell having a peripheral flange formed thereon and an outlet formed therein; a second housing shell adapted to be assembled with the first housing shell and having a peripheral flange formed thereon and an inlet formed therein; and a filter element adapted to have a peripheral portion thereof compressed between the flange of the first housing shell and the flange of the second housing shell.

In another embodiment, the filtration assembly comprises a first housing shell having a laterally outwardly extending peripheral flange formed thereon and an outlet formed therein, wherein the flange has at least one protuberance; a second housing shell adapted to be assembled with the first housing shell and having a laterally outwardly extending peripheral flange formed thereon to cooperate with the first housing shell and an inlet formed therein, wherein the flange has at least one indentation; and a filter element adapted to have a peripheral portion thereof compressed between the flange of the first housing shell and the flange of the second housing shell.

In another embodiment, the filtration assembly comprises a first housing shell, having a laterally outwardly extending peripheral flange formed thereon and an outlet formed therein, wherein the flange has at least one protuberance having a substantially rectangular cross-sectional shape; a second housing shell adapted to be assembled with the first housing shell and having a laterally outwardly extending peripheral flange formed thereon to cooperate with the first housing shell and an inlet formed therein, wherein the flange has at least one indentation; and a filter element having at least a portion thereof formed from a foam, a peripheral portion of the filter element compressed between the flange of the first housing shell and the flange of the second housing shell, wherein the compressed portion contacts the base of the indention of the second housing shell to substantially fill a leak path formed between the flange of the first housing shell and the flange of the second housing shell.

A filtration assembly of the present invention is particularly useful for providing filtration for an internal combustion engine.

### DESCRIPTION OF THE DRAWINGS

The above, as well as other advantages of the present invention, will become readily apparent to those skilled in the art from the following detailed description of an exemplary embodiment when considered in the light of the accompanying drawings in which:

FIG. 1 is a top plan view of a air filtration assembly according to an embodiment of the invention; and

FIG. 2 is a cross-sectional view of the air filtration assembly of FIG. 1 taken along line 2-2.

### DETAILED DESCRIPTION OF EXEMPLARY EMBODIMENTS OF THE INVENTION

The following detailed description and appended drawings describe and illustrate various exemplary embodiments of the present invention. The description and drawings serve to enable one skilled in the art to make and use the invention, and are not intended to limit the scope of the invention in any manner. It is understood that materials other than those described can be used without departing from the scope and spirit of the invention.

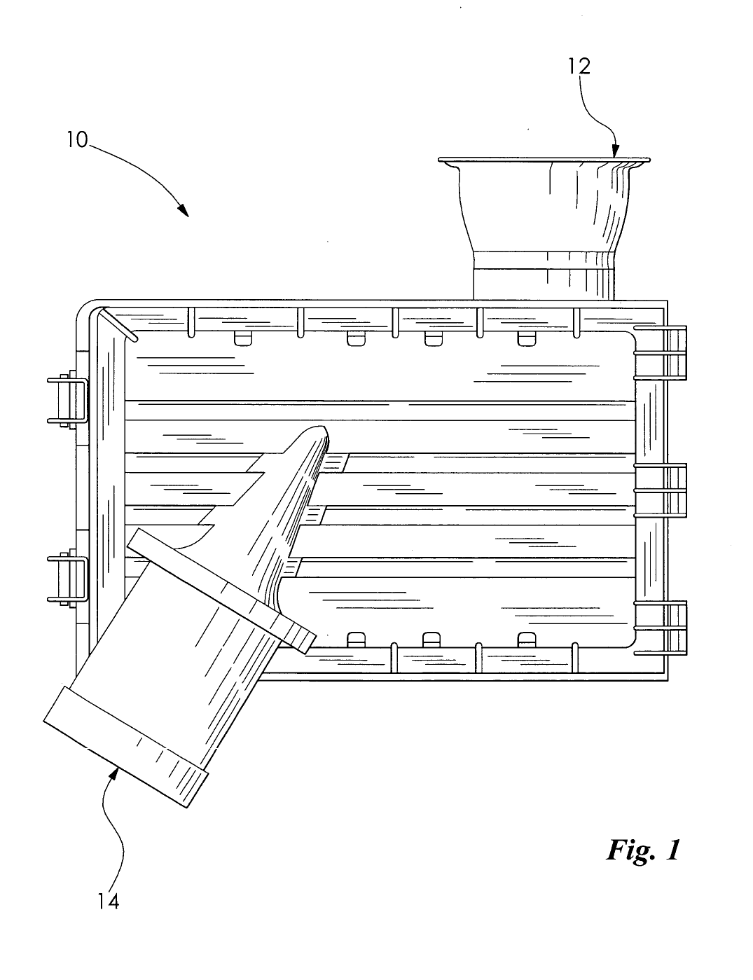

FIG. 1 shows a filtration device or filtration housing 10. The housing 10 may be made of conventional materials such as polypropylene for example. In the embodiment shown, the housing 10 has a substantially rectangular shape. It is understood that the housing 10 can have other shapes as desired. The housing 10 includes an inlet 12 and an outlet 14. The inlet 12 is formed in a second housing shell 22 of the housing 10 and the outlet is formed in a first housing shell 18 of the housing 10. It is understood that the inlet 12 and the outlet 14 may be formed elsewhere on the housing 10 if desired. The inlet 12 draws unfiltered external air into the filtration housing 10. The outlet 14 is in communication with an internal combustion engine (not shown), for example. It is understood that the outlet 14 can be in communication with other types of engines as desired without departing from the scope and spirit of the invention.

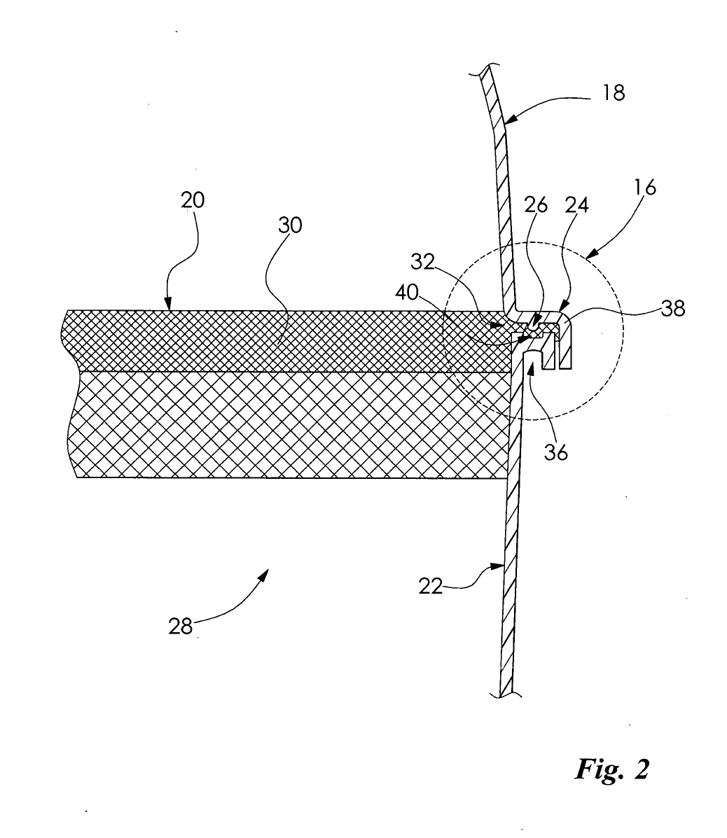

In FIG. 2 a flanged joint 16 according to the present invention is illustrated. The filtration housing 10 includes the first housing shell 18, the second housing shell 22, and a filter element 20. The first housing shell 18 and the second housing shell 22 cooperate to form a hollow interior therebetween.

The first housing shell 18 can be produced from and conventional material such as polypropylene, for example. The first housing shell 18 has a laterally outwardly extending peripheral flange 24 formed thereon. A protuberance 26 is formed on the flange 24 around the periphery of the first housing shell 18. In the embodiment shown, the protuberance 26 has a substantially rectangular cross-sectional shape, although other cross-sectional shapes can be use as desired such as triangular and arcuate, for example.

The second housing shell 22 can be produced from any conventional material such as polypropylene, for example. The second housing shell 22 has a laterally outwardly extending peripheral flange 36 formed thereon. The flange 36 is adapted to receive the flange 24 of the first housing shell 18. An indentation 38 is formed on the flange 36 around the periphery of the second housing shell 22 and is adapted to receive the protuberance 26 therein. It is understood the protuberance 26 can be formed on the second housing shell 22 and the indentation 38 can be formed on the first housing shell 18, if desired.

The filter element 20 separates an unfiltered area 28 of the filtration housing 10 from a filtered area 30 of the filtration housing 10. The filter element 20 may be prepared from at least one layer of filter media, such as a foam media. Optionally, the filter element 20 may include support screens (not shown) disposed thereon. The support screens may be formed integrally with or separately from the filter element 20 as desired. The support screens may also be disposed on the first housing shell 18 and or the second housing shell 22 as desired. The filter element 20 has a mesh or pore size large enough to allow air to pass through, yet small enough to effectively capture desired impurities such as particulate matter. A peripheral portion 32 of the filter element 20 is oversized to extend between the flanges 24, 36. The portion 32 of the filter element 20 may be prepared from the same filter media, or a different filter media as the filter element 20, as desired. It may be desirable to have the shape and outer dimensions of the filter element 20 conform to the shape of the housing 10.

The housing 10 may be assembled by inserting the filter element 20 into the second housing shell 22, wherein the peripheral portion 32 of the filter element 20 is in contact with the flange 36 of the second housing shell 22. The first housing shell 18 is then disposed on the second housing shell 22, wherein the flange 24 of the first housing shell 18 and the flange 36 of the second housing shell 22 are substantially aligned. The first housing shell 18 and the second housing shell 22 are compressed together and produce a flanged joint 16 having an interference fit. It is understood that other joining methods can be used such as fasteners and clips, for example.

The filter element 20 is held in a desired position by the compression of the peripheral portion 32 of the filter element 20 between the flanges 24, 36. The peripheral portion 32 is compressed by the mating of the protuberance 26 on the flange 24 of the first housing shell 18 with the corresponding indentation 38 in the flange 36 of the second housing shell 22. The peripheral portion 32 of the filter element 20 contacts a base portion of the indentation 38, thus completely filling the leak path 40 created between the flanges 24, 36. In the embodiment shown, the peripheral portion 32 of the filter element 20 does not seal the flanged joint 16, but allows air to pass through the flanged joint 16 via the leak path 40, thus filtering the air if leaking into the filtration housing 10. It is understood that the peripheral portion 32 can provide a substantially air-tight seal if desired.

In operation, the housing 10 filters the unfiltered external air drawn into the inlet 12 for use in an internal combustion engine, for example. It is understood that the housing 10 can be disposed in other types of engines as desired without departing from the scope and spirit of the invention. The unfiltered air passes through the filter element 20, wherein the contaminants are removed and captured. Thereafter, the filtered air is permitted to travel to the internal combustion engine through the outlet 14. Any air permitted to be drawn through the leak path 40 and into the housing 10 is filtered, thus eliminating a need for an air-tight seal and militating against introduction of contaminants to the housing through the leak path 40.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A filtration device comprising:
a first housing shell having a peripheral flange formed thereon and an outlet formed therein;
a second housing shell adapted to be assembled with said first housing shell and having a peripheral flange formed thereon and an inlet formed therein; and
a filter element adapted to have a peripheral portion thereof compressed between the flange of said first housing shell and the flange of said second housing shell.

2. The filtration device according to claim 1, wherein the flange of said first housing shell extends laterally outwardly from said first housing shell.

3. The filtration device according to claim 2, wherein the flange of said first housing shell has at least one protuberance.

4. The filtration device according to claim 3, wherein the protuberance has a substantially rectangular cross-sectional shape.

5. The filtration device according to claim 4, wherein the flange of said second housing shell extends laterally outwardly from said second housing shell.

6. The filtration device according to claim 5, wherein the flange of said second housing shell has an indentation formed therein.

7. The filtration device according to claim 6, wherein the protuberance cooperates with the indentation to secure said filter element between the flange of said first housing shell and the flange of said second housing shell.

8. The filtration device according to claim 7, wherein the compressed peripheral portion of the filter element contacts a base of the indentation.

9. The filtration device according to claim 1, wherein the flange of said first housing shell and the flange of said second housing shell are adapted to have an interference fit.

10. The filtration device according to claim 1, wherein said filter element is produced from a foam.

11. The filtration device according to claim 1, wherein said filter element includes at least one layer of a foam.

12. An air filtration device comprising:
a first housing shell having a laterally outwardly extending peripheral flange formed thereon and an outlet formed therein, wherein the flange has at least one protuberance;
a second housing shell adapted to be assembled with said first housing shell and having a laterally outwardly extending peripheral flange formed thereon to cooperate with said first housing shell and an inlet formed therein, wherein the flange has at least one indentation; and
a filter element adapted to have a peripheral portion thereof compressed between the flange of said first housing shell and the flange of said second housing shell.

13. The air filtration device according to claim 12, wherein the peripheral portion of said filter contacts a base of the indention of said second housing shell.

14. The air filtration device according to claim 12, wherein the protuberance has a substantially rectangular cross-sectional shape.

15. The air filtration device according to claim 12, wherein the protuberance cooperates with the indentation to secure said filter element.

16. The air filtration device according to claim 12, wherein the flange of said first housing shell and the flange of said second housing shell are adapted to have an interference fit.

17. The air filtration device according to claim 12, wherein at least a portion of said filter element is produced from a foam.

18. An air filtration device comprising:
a first housing shell, having a laterally outwardly extending peripheral flange formed thereon and an outlet formed therein, wherein the flange has at least one protuberance having a substantially rectangular cross-sectional shape;
a second housing shell adapted to be assembled with said first housing shell and having a laterally outwardly extending peripheral flange formed thereon to cooperate with said first housing shell and an inlet formed therein, wherein the flange has at least one indentation; and
a filter element having at least a portion thereof formed from a foam, a peripheral portion of said filter element compressed between the flange of said first housing shell and the flange of said second housing shell, wherein the compressed portion contacts the base of the indention of said second housing shell to substantially fill a leak path formed between the flange of said first housing shell and the flange of said second housing shell.

19. The air filtration device according to claim 18, wherein the protuberance cooperates with the indentation to secure said filter element.

20. The air filtration device according to claim 18, wherein the flange of said first housing shell and the flange of said second housing shell are adapted to have an interference fit.
